(19) United States
(12) Patent Application Publication
(10) Pub. No.: US 2019/0300173 A1
(43) Pub. Date: Oct. 3, 2019

(54) Bulkhead Partition Design, Seating Arrangement and Method for Using the Same

(71) Applicant: The Boeing Company, Chicago, IL (US)

(72) Inventor: Eric E. Thomas, St. Charles, MO (US)

(21) Appl. No.: 15/938,065

(22) Filed: Mar. 28, 2018

(51) Int. Cl. B64D 11/00; B64C 1/10; B64D 11/06

(52) U.S. Cl. CPC B64D 11/0023; B64D 11/0605; B64C 1/10

(57) ABSTRACT

A bulkhead partition for a passenger cabin of an aircraft includes an upper portion and a lower portion, with the lower portion forming a compartment that provides additional storage and/or foot space for passengers seated in the row of seats directly behind the bulkhead partition. Related passenger seating arrangements and methods are also disclosed.

### TECHNOLOGICAL FIELD

The present disclosure relates generally to bulkheads for dividing passenger seating classes, and more particularly, to a bulkhead partition design that provides an open storage compartment for an aft positioned row of seats.

### BACKGROUND

Cabins in passenger aircraft are typically divided into various sections (“class sections”) for various reasons. For example, a cabin may have premium class seating at the forward end of the passenger cabin and economy class seating behind the premium class seating. Classes are typically divided at the boundary between class sections by a bulkhead extending from floor to ceiling, and in the aisle by a curtain. Premium class seating typically includes larger, more comfortable seats, a less dense seating arrangement commensurate with the level of luxury of the seats. Economy class seating typically includes smaller seats and a more dense seating arrangement. For example, economy class rows may include three seats, while an equal length row in a premium class may include only two seats.

For most partitions that are typically employed, the presence of the partition precludes the passengers in the front-most row of seats of the economy class from utilizing the space under the seats in the row in front of them—the last row of premium class seats—for storage of luggage or personal items, or for positioning their feet. This lack of under-seat storage places additional demand for the storage space provided in the overhead bins, which may be inadequate. As such, there is a need for alternative bulkhead partition designs, particularly ones that allow for more efficient use of space while maintaining separation between the classes of seating.

### SUMMARY

Aspects of the present disclosure are directed to a bulkhead partition, and to related passenger seating arrangements and methods. The bulkhead partition includes an upper portion and a lower portion, with the lower portion having a compartment that provides additional storage and/or foot space.

In one or more aspects, the present disclosure provides an aircraft, and/or a passenger seating arrangement for a passenger cabin of an aircraft, comprising a first row of seats, a second row of seats, and a bulkhead partition. The first row of seats is in a forward section of the passenger cabin. The second row of seats is disposed behind the first row of seats in a rearward section of the passenger cabin. The bulkhead partition is disposed between the first row of seats and the second row of seats. The bulkhead partition comprises an upper section and a lower section. The upper section extends upwardly between the first row of seats and the second row of seats. The lower section is disposed below the upper section. The lower section extends forwardly from the upper section and underneath the first row of seats. The lower section forms a compartment underneath the first row of seats. The lower section comprises a forward compartment wall, a first compartment lateral wall, an upper compartment wall, and a rear opening. The forward compartment wall is disposed forward of the compartment and forwardly bounds the compartment. The first compartment lateral wall is disposed on a first lateral side of the compartment and bounds the first lateral side of the compartment. The upper compartment wall is disposed above the compartment and upwardly bounds the compartment. The upper compartment wall extends from, and connects, the upper section to the forward compartment wall. The rear opening provides access to the compartment from the second row of seats.

In some aspects, the lower section further comprises a second compartment lateral wall disposed on a second lateral side of the compartment and bounding the second lateral side of the compartment. In some aspects, the lower section further comprises a base compartment wall affixed to a floor of the passenger cabin, with the base compartment wall extending horizontally and rearwardly from the forward compartment wall.

In one or more other aspects, the present disclosure provides a bulkhead partition for a passenger cabin having a first row of seats and a second row of seats disposed behind the first row of seats. The bulkhead partition comprises an upper section and a lower section. The upper section extends upwardly. The lower section is disposed below the upper section. The lower section extends forwardly from the upper section. The lower section comprises a compartment, a forward compartment wall, a first compartment lateral wall, an upper compartment wall, and a rear opening. The forward compartment wall is disposed forward of the compartment and forwardly bounds the compartment. The first compartment lateral wall is disposed on a first lateral side of the compartment and bounds the first lateral side of the compartment. The upper compartment wall is disposed above the compartment and upwardly bounds the compartment. The upper compartment wall extends from, and connects, the upper section to the forward compartment wall. The compartment is rearwardly open at the rear opening. The lower section is configured to extend beneath the first row of seats when the bulkhead partition is disposed between first row of seats and the second row of seats.

In some aspects of the bulkhead partition, the lower section further comprises a second compartment lateral wall disposed on a second lateral side of the compartment and bounding the second lateral side of the compartment. In some aspects of the bulkhead partition, the lower section further comprises a base compartment wall configured to be affixed to a floor of the passenger cabin, with the base compartment wall extending horizontally and rearwardly from the forward compartment wall.

In one or more other aspects, the present disclosure provides a method of providing additional storage in a passenger cabin having a first row of seats and a second row of seats disposed behind the first row of seats. Such a method includes providing a bulkhead partition. The bulkhead partition comprises an upper section and a lower section. The upper section extends upwardly. The lower section is disposed below the upper section. The lower section extends forwardly from the upper section. The lower section comprises a compartment, a forward compartment wall, a first compartment lateral wall, an upper compartment wall, and a rear opening. The forward compartment wall is disposed forward of the compartment and forwardly bounds the compartment. The first compartment lateral wall is disposed on a first lateral side of the compartment and bounds the first lateral side of the compartment. The upper compartment wall is disposed above the compartment and upwardly bounds the compartment. The upper compartment wall extends from, and connects, the upper section to the forward compartment wall. The compartment is rearwardly open at the rear opening. The lower section is configured to extend beneath the first row of seats when the bulkhead partition is disposed between the first row of seats and the second row of seats. The method also includes securing the bulkhead partition between the first row of seats and the second row of seats such that: 1) the upper section extends upwardly between the first row of seats and the second row of seats; 2) the lower section extends forwardly from the upper section and underneath the first row of seats; and 3) the rear opening provides access to the compartment from the second row of seats. In some aspects, the securing the bulkhead partition includes affixing the bulkhead partition to the floor of the passenger cabin and/or the ceiling of the passenger aircraft passenger cabin. In some aspects, the method includes, prior to the securing, detaching an existing bulkhead partition so that the bulkhead partition described herein may be installed as an upgrade and/or replacement.

The features, functions and advantages that have been discussed can be achieved independently in various aspects or may be combined in yet other aspects further details of which can be seen with reference to the following description and the drawings.

### BRIEF DESCRIPTION OF THE DRAWINGS

Having thus described variations of the disclosure in general terms, reference will now be made to the accompanying drawings, which are not necessarily drawn to scale.

FIG. 1 shows a perspective view of an exemplary aircraft that incorporates aspects of the present disclosure.

FIG. 2. shows a partial cross-sectional view of the aircraft of FIG. 1, showing a rearmost row of seats in a forward section of the passenger cabin, a bulkhead partition, and a frontmost row of seats of a rearward section of the passenger cabin.

FIG. 3 shows a perspective view of a bulkhead partition [upper is straight] according to aspects of the present disclosure.

FIG. 4 shows a side view of the bulkhead partition of FIG. 3.

FIG. 5 shows a forward facing view of the bulkhead partition of FIG. 3.

FIG. 6 shows a side view of another bulkhead partition [upper is curving backward] according to aspects of the present disclosure.

FIG. 7 shows a flowchart pertaining to aspects of the present disclosure.

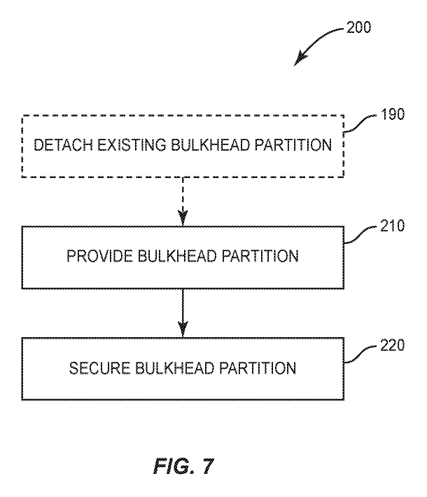

### DETAILED DESCRIPTION

Aspects of the present disclosure are directed to a bulkhead partition, and to related passenger seating arrangements and methods. The bulkhead partition includes an upper portion and a lower portion, with the lower portion having a compartment that provides additional storage and/or foot space. The bulkhead partition is intended for use with aircraft, and finds particular utility in passenger aircraft.

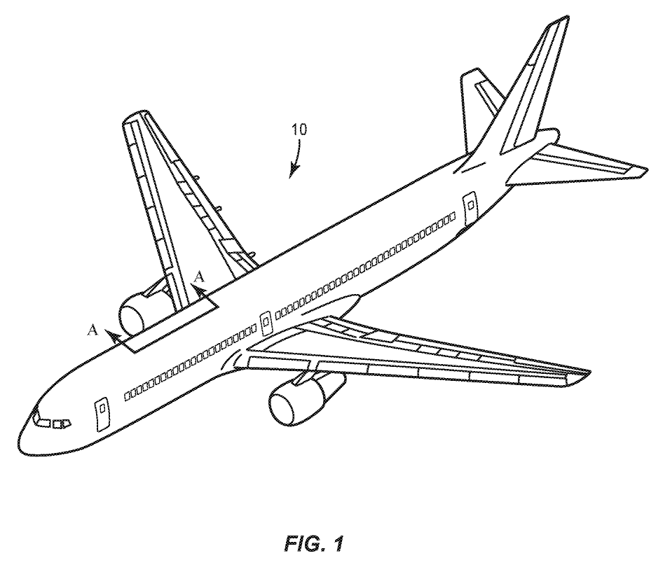

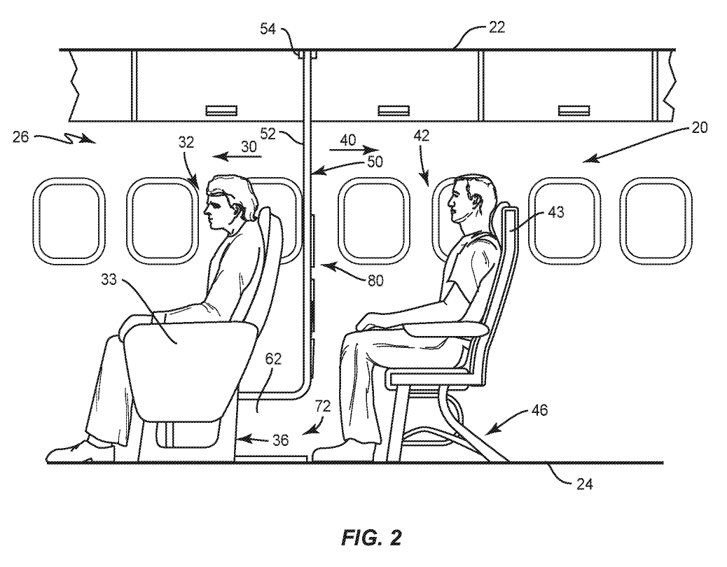

FIG. 1 shows a perspective view of an exemplary aircraft 10, and FIG. 2 shows a partial cross-sectional view along line A-A in FIG. 1. As can be seen, the aircraft 10 includes at least one passenger cabin 20 that has a ceiling 22, a floor 24, seats, and one or more bulkhead partitions 52. The locations of seats and bulkhead partition(s) 52 defines a passenger seating arrangement 26. In some aspects, the aircraft 10 includes one passenger cabin 20; in some aspects, the aircraft 10 includes two or more passenger cabins 20. The passenger cabin 20 has a passenger seating arrangement 26 that includes at least two sections, such as the forward section 30 and a rearward section 40. In some aspects, the forward section 30 and the rearward section 40 may have different levels of service and/or amenities. For example, the forward section 30 may be a premium class section and the rearward section 40 may be an economy class section. In some aspects, the forward section 30 and the rearward section 40 have the same level of service and/or amenities. A first row of seats 32 is disposed in the forward section 30 of the passenger cabin 20. The first row of seats 32 corresponds to the last row, or rearmost row, of seats in the forward section 30. In some aspects, the first row of seats 32 comprises a plurality of seats, including a first front seat 33 and a second front seat (not shown). A second row of seats 42 is disposed behind the first row of seats 32 and in the rearward section 40 of the passenger cabin 20. The second row of seats 42 corresponds to the forwardmost row of seats in the rearward section 40. In some aspects, the second row of seats 42 comprises a plurality of seats, including a first rear seat 43, a second rear seat (not shown), and a third rear seat (not shown). The first row of seats 32 and the second row of seats 42 have corresponding (load-bearing) support structures 36, 46 that connect the seats to the floor of the passenger cabin 20, and support the seats and the loads placed therein (e.g., the weight of the passenger in that seat). A bulkhead partition 50 is disposed between the first row of seats 32 and the second row of seats 42, and delineates the boundary between the forward section 30 and the rearward section 40 of the passenger cabin 20.

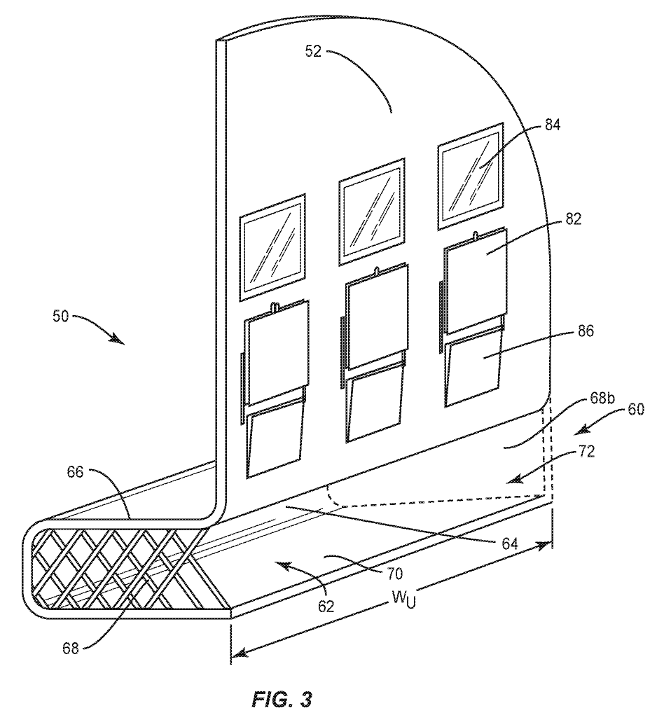

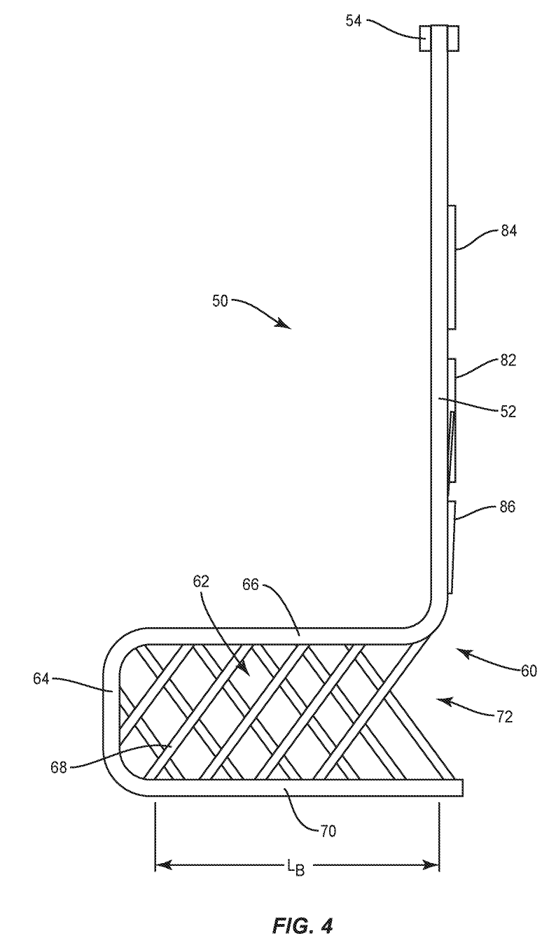

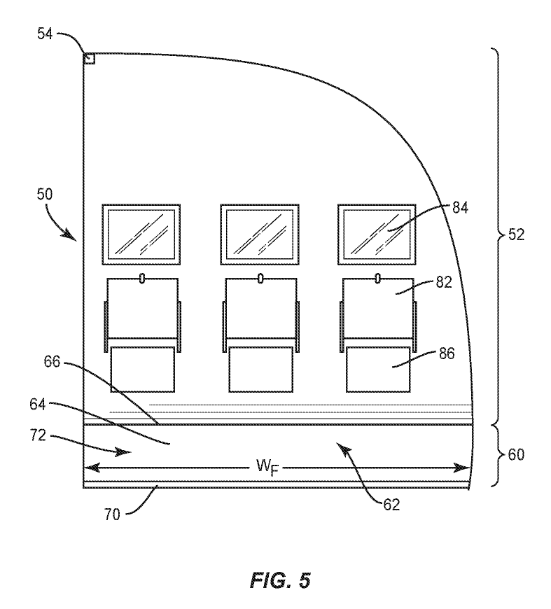

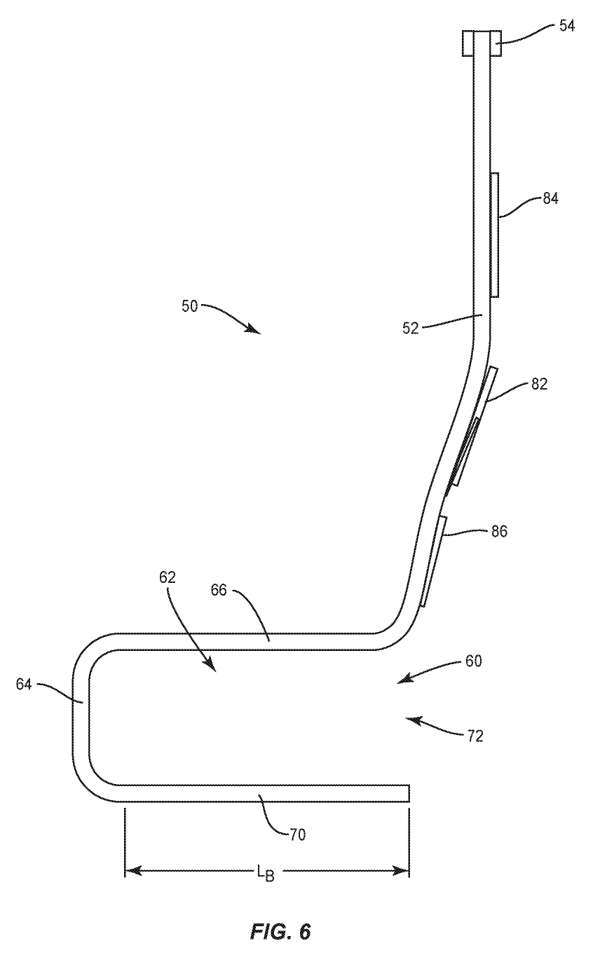

Referring to FIGS. 3-6, the bulkhead partition 50 includes an upper section 52 and a lower section 60. The upper section 52 extends upwardly between the first row of seats 32 and the second row of seats 42. In some aspects, the upper section 52 is straight (in side view), see FIGS. 3-5; in some aspects the upper section 52 may be rearwardly angled and/or curved (in side view), see FIG. 6, and/or otherwise recessed so as to more readily provide the first row of seats 32 space to recline. In some aspects, the upper and outboard lateral edges of the upper section 52 are curved so as to match and/or accommodate a curved cross-sectional shape of the passenger cabin 20. In some aspects, the upper and outboard lateral edges are straight or straight and curved. The inboard lateral edge of the upper section 52 is advantageously straight and/or curved so as to provide a desired visual boundary for an associated aisle. In some aspects, the upper section 52 is configured to and/or does extend above a level of an overhead storage bin; in some aspects the upper section 52 is configured and/or does not extend above a level of an overhead storage bin.

The lower section 60 is disposed below the upper section 52. The lower section 60 extends forwardly from the upper section 52. This forward extension is so that a portion of the lower section 60 extends underneath the first row of seats 32 when the bulkhead partition 50 is mounted in position. The lower section 60 forms a compartment 62, which, when installed, is disposed underneath the first row of seats 32. The lower section 60 includes a forward compartment wall 64, a first compartment lateral wall 68, an upper compartment wall 66, and a rear opening 72. The forward compartment wall 64 is disposed forward of the compartment 62 and forwardly bounds the compartment 62. The first compartment lateral wall 68 is disposed on a first lateral side of the compartment 62 and bounds the first lateral side of the compartment 62. In FIGS. 3-6, the first lateral side of the compartment 62 is disposed toward the inboard side (e.g., toward a center aisle) of the passenger cabin 20. In some aspects, the lower section 60 also includes a second compartment lateral wall 68b that is disposed on a second lateral side of the compartment 62 and bounds the second lateral side of the compartment 62. The second lateral side is opposite the first lateral side, and for the FIGS. 3-6 illustration, the second lateral side is toward the outboard side (e.g., toward the window side) of the passenger cabin 20. Second compartment lateral wall 68b is shown in FIG. 3 in dashed lines to indicate that it is optional. Thus, in some aspects, there is no second compartment lateral wall 68b. The upper compartment wall 66 is disposed above the compartment 62 and upwardly bounds the compartment 62. The upper compartment wall 66 extends from, and connects, the upper section 52 to the forward compartment wall 64. In some aspects, the upper compartment wall 66 is disposed horizontally and/or is generally planar. In some aspects, both the upper compartment wall 66 and the forward compartment wall 64 have respective widths W_{U} and W_{F} that are wider than the first front seat 33, and advantageously as wide as the combined width of the second row of seats 42. The rear opening 72 provides access to the compartment 62 from the second row of seats 42, and likewise, in some aspects, has a width Wo that is wider than the first front seat, advantageously as wide as the combined width of the second row of seats 42.

The forward compartment wall 64, and the first and second compartment lateral walls 68,68b are solid, and/or formed by mesh, and/or formed by webbing, and/or any combination thereof. Thus, in some aspects, the forward compartment wall 64 is solid, and the first compartment lateral wall 68 is webbing. In some aspects, both the forward compartment wall 64 and the first compartment lateral wall 68 are solid. In some aspects, the forward compartment wall 64 extends continuously along substantially all of a forward perimeter of the compartment 62. In some aspects, the first compartment lateral wall 68 extends continuously along substantially all of a first lateral side perimeter of the compartment 62.

In some aspects, the lower section 60 further includes a base compartment wall 70 disposed below the compartment 62. The base compartment wall 70 is advantageously affixed to a floor of the passenger cabin 20, such as by suitable fasteners. The base compartment wall 70 extends horizontally and rearwardly from the forward compartment wall 64. In some aspects, the base compartment wall 70 has a length (in side view) L_{B} similar to the upper compartment wall 66, such that the rear opening 72 is defined between the upper compartment wall 66 and the base compartment wall 70. In some aspects, the base compartment wall 70 has a different length, for example being shorter than the upper compartment wall 66, so that the rear opening 72 is defined between the upper compartment wall 66 and a theoretical rearward projection of the base compartment wall 70.

In some aspects, the forward compartment wall 64 and/or the upper compartment wall 66 and/or the base compartment wall 70 include one or more suitable notches or recessed areas for accommodating the support structure 36 for the first row of seats 32. In some aspects, these notch(es) or recessed area(s) wholly or partially subdivide the compartment 62 in two or more sub-compartment areas (not shown).

In some aspects, the upper section 52 is fitted with amenities 80 that face and serve the second row of seats 42. The amenities 80, in some aspects, include one or more of: one or more tray tables 82, and/or one or more video monitors 84, and/or one or more storage pockets 86. In some aspects, the upper section 52 is fitted with a number of like amenities 80 equal in number to the number of seats in the second row of seats 42. In some aspects, the number of like amenities 80 are more or less than the number of seats in the second row of seats 42. In some aspects, the bulkhead partition 50 supports a curtain or other movable divider that is selectively positionable to visually close of an aisle in the passenger cabin 20.

In some aspects, the upper section 52 of the bulkhead partition 50 is affixed to the ceiling 22 of the passenger cabin 20. For example, the upper section 52 may include attachment flanges 54 for accepting fasteners to affix the upper section 52 to the ceiling 22. In some aspects, the bulkhead partition 50 is affixed to both the ceiling 22 and the floor 24 of the passenger cabin 20, and extends therebetween.

The bulkhead partition 50 provides a compartment 62, which is intended to be used for storage of baggage and other personal items, typically belonging to one or more passengers sitting in the second row of seats 42. In addition, the compartment 62 may be used for positioning such passenger's feet. One or both of these functionalities are achieved by the bulkhead partition 50. In some aspects, the bulkhead partition 50 forms no portion of the support structure 36 for the first row of seats 32, and maintains a boundary between the forward and rearward sections 30,40 of the passenger cabin 20. Further, in some aspects, no portion of the bulkhead partition 50 extends farther forward than forwardmost portion of the first row of seats 32, so that the bulkhead partition 50 does not extend into the space intended for use by the passengers of the forward section 30.

The bulkhead partition 50 facilitates a method 200 of providing additional storage in the passenger cabin 20. Such a method 200 includes providing (step 210) the bulkhead partition 50 with the compartment 62 in the lower section 60, as described above. The method 200 also includes securing (step 220) the bulkhead partition 50 between the first row of seats 32 and the second row of seats 42 such that: 1) the upper section 52 extends upwardly between the first row of seats 32 and the second row of seats 42; 2) the lower section 60 extends forwardly from the upper section 52 and underneath the first row of seats 32; and 3) the rear opening 72 provides access to the compartment 62 from the second row of seats 42. In some aspects, the securing the bulkhead partition 50 includes affixing the bulkhead partition 50 to the floor 24 of the passenger cabin 20 and/or the ceiling 22 of the passenger cabin 20.

Note that the bulkhead partition 50, and/or the associated passenger seating arrangement 26, and/or method 200, can be used during original manufacture of an aircraft 10, or during repair and/or maintenance of the aircraft 10. For example, an existing aircraft, having a conventional bulkhead partition, may be serviced by following a method 200 that includes detaching (step 190) the existing conventional bulkhead partition from the aircraft 10, and providing (step 210) the bulkhead partition 50 with the compartment 62 in the lower section 60, as described above, and then securing (step 220) the bulkhead partition 50 between the first row of seats 32 and the second row of seats 42, as described above and optionally in the same location as the detached (old) bulkhead partition. Note that the providing (step 210), in some aspects, occurs prior to the detaching (step 190); in other aspects, the providing (step 210) occurs after or concurrent with the detaching (step 190). Such a servicing would achieve providing additional storage in the passenger cabin 20, by providing the bulkhead partition 50 described herein as an upgrade and/or replacement.

The bulkhead partition 50 may be formed of any suitable material, such as metals, polymer materials, composite materials, or combinations thereof. Additionally, passenger facing surfaces of the bulkhead partition may fully or partially covered with suitable paint, graphics, and/or fabric for a desired aesthetic appearance.

The present disclosure may, of course, be carried out in other ways than those specifically set forth herein without departing from essential characteristics of the disclosure. The present embodiments are to be considered in all respects as illustrative and not restrictive, and all changes coming within the meaning and equivalency range of the appended claims are intended to be embraced therein.

What is claimed is:

1. A passenger seating arrangement for a passenger cabin of an aircraft, the passenger seating arrangement comprising:
a first row of seats in a forward section of the passenger cabin;
a second row of seats disposed behind the first row of seats in a rearward section of the passenger cabin;
a bulkhead partition disposed between the first row of seats and the second row of seats; and
wherein the bulkhead partition comprises:
an upper section that extends upwardly between the first row of seats and the second row of seats;
a lower section disposed below the upper section, the lower section extending forwardly from the upper section and underneath the first row of seats; the lower section forming a compartment underneath the first row of seats;
wherein the lower section comprises:
a forward compartment wall disposed forward of the compartment and forwardly bounding the compartment;
a first compartment lateral wall disposed on a first lateral side (of the compartment and bounding the first lateral side of the compartment;
an upper compartment wall disposed above the compartment and upwardly bounding the compartment; wherein the upper compartment wall extends from, and connects, the upper section to the forward compartment wall; and
a rear opening providing access to the compartment from the second row of seats.

2. The passenger seating arrangement of claim 1, wherein upper section is straight.

3. The passenger seating arrangement of claim 1, wherein the upper section is affixed to a ceiling of the passenger cabin.

4. The passenger seating arrangement of claim 1:
wherein the forward compartment wall is solid; and
wherein the first compartment lateral wall is webbing.

5. The passenger seating arrangement of claim 1, wherein the lower section further comprises a second compartment lateral wall disposed on a second lateral side of the compartment and bounding the second lateral side of the compartment, the second lateral side being opposite the first lateral side.

6. The passenger seating arrangement of claim 1:
wherein the first row of seats comprises a plurality of seats, including a first front seat; and
wherein both the upper compartment wall and the forward compartment wall are wider than the first front seat.

7. The passenger seating arrangement of claim 1:
wherein the lower section further comprises a base compartment wall affixed to a floor of the passenger cabin;
wherein the base compartment wall extends horizontally and rearwardly from the forward compartment wall; and
wherein the base compartment wall is disposed below the compartment.

8. The passenger seating arrangement of claim 1, wherein the upper section is fitted with amenities that face and serve the second row of seats.

9. The passenger seating arrangement of claim 8:
wherein the upper section is fitted with a number of like amenities equal in number to a number of seats in the second row of seats; and
wherein the amenities include one or more of: tray tables, video monitors, and storage pockets.

10. An aircraft comprising the passenger seating arrangement of claim 1.

11. A bulkhead partition for a passenger cabin of an aircraft, the passenger cabin having a first row of seats and a second row of seats disposed behind the first row of seats, the bulkhead partition comprising:
an upper section that extends upwardly;
a lower section disposed below the upper section, the lower section extending forwardly from the upper section and comprising:
a compartment that extends forwardly;
a forward compartment wall disposed forward of the compartment and forwardly bounding the compartment;
a first compartment lateral wall disposed on a first lateral side of the compartment and bounding the first lateral side of the compartment;
an upper compartment wall disposed above the compartment and upwardly bounding the compartment; wherein the upper compartment wall extends from, and connects, the upper section to the forward compartment wall;
wherein the compartment is rearwardly open at a rear opening; and
wherein the lower section is configured to extend beneath the first row of seats when the bulkhead partition is disposed between first row of seats and the second row of seats.

12. The bulkhead partition of claim 11, wherein the upper section is straight.

13. The bulkhead partition of claim 11, wherein upper section is rearwardly curved.

14. The bulkhead partition of claim 11, wherein the first compartment lateral wall is solid.

15. The bulkhead partition of claim 11, wherein the first compartment lateral wall is webbing.

16. The bulkhead partition of claim 11, wherein the lower section further comprises a second compartment lateral wall disposed on a second lateral side of the compartment and bounding the second lateral side of the compartment, the second lateral side being opposite the first lateral side.

17. The bulkhead partition of claim 11, wherein the upper section is configured to be affixed to a ceiling of the passenger cabin.

18. The bulkhead partition of claim 11:
wherein the lower section further comprises a base compartment wall configured to be affixed to a floor of the passenger cabin;
wherein the base compartment wall extends horizontally and rearwardly from the forward compartment wall; and
wherein the base compartment wall is disposed below the compartment.

19. The bulkhead partition of claim 11, wherein the upper section is fitted with amenities that face and serve the second row of seats.

20. The bulkhead partition of claim 19:
wherein the upper section is fitted with a number of like amenities equal in number to a number of seats in the second row of seats;
wherein the amenities include one or more of: tray tables, video monitors, and storage pockets.
